(19) United States
(12) Patent Application Publication
(10) Pub. No.: US 2011/0260006 A1
(43) Pub. Date: Oct. 27, 2011

(54) Nejat kinematics and kinetics expansions spacecraft

(76) Inventor: Cyrus Mohammad Ali Nejat, Los Angeles, CA (US)

(21) Appl. No.: 12/932,226

(22) Filed: Jan. 11, 2010

(51) Int. Cl. B64G 1/10; G06F 17/10; G06G 7/72; B64G 1/12

(52) U.S. Cl. 244/158.6; 244/158.1; 703/2; 703/8

(57) ABSTRACT

This project is related to the inventor, Cyrus Nejat, previous patent Application Number: U.S. Ser. No. 12/011,127. In this study, the main discussion emphasizes on building a spacecraft based on mathematics. The orientation of the low thrust engine spacecraft was structured in such a way that the Kinematics and kinetics equations be written for large elements, by means of the purposed Nejat Kinetics Expansions and Nejat Kinematics Expansions. These equations were used to design Nejat Space Station. Simplified CN (Cyrus Nejat) Equations of Motion used for the Special Spacecraft Rout in Space.

### CHAPTER 1

### Introduction

### 1.1 Problem Statement

To build an efficient spacecraft that is built based on mathematics.

### 1.2 Solution

Nejat Kinematics and Kinetics Expansions Spacecraft is built based on Nejat Kinematics Expansions, and Nejat Kinetics Expansions. The system was simulated to Nejat Simulation Configuration and Nejat space station.

### CHAPTER 2

### Nejat Kinematics Expansions

### 2.1 Nejat Kinematics Expansions

Kinematics is a portion of physics that is concerned with the position, velocity, and acceleration of an object. For the Cyrus Nejat-Electromagnetic Solar Sail Spacecraft, Nejat Kinematics Expansions were developed. In these expansions, the kinematics of spacecraft is the main concern. In the Nejat Expansions, a is the number of vectors. By means of the purposed Nejat Kinematics Expansions (developed and discovered by Cyrus Nejat).

$$\begin{matrix} {}^{o} \vec{N} = {\sum }_{K = 1}^{a} {r}_{K} {\hat{P}}_{K} & ( 2.1 ) \\ { }^{o} \vec{\dot{N}} = {\sum [ {\dot{r}}_{K} {\hat{P}}_{K} + {r}_{K} ( {\sum }_{m = 1}^{K} {\dot{β}}_{m} ) {\hat{Q}}_{K} ]}_{K = 1}^{a} & ( 2.2 ) \\ {}^{o} \vec{\ddot{N}} = {\sum }_{K = 1}^{a} [ \{ {\ddot{r}}_{K} - {{r}_{K} ( {\sum }_{m = 1}^{K} {\dot{β}}_{m} )}^{2} \} {\hat{P}}_{K} + \{ {r}_{K} ( {\sum }_{m = 1}^{K} {\ddot{β}}_{m} ) + 2 {\dot{r}}_{K} ( {\sum }_{m = 1}^{K} {\dot{β}}_{m} ) \} {\hat{Q}}_{K} ] & ( 2.3 )\end{matrix}$$

where r_{K} is the position vector, \hat{P}_{K} and \hat{Q}_{K} are the unit vectors, βₘ is relative angle.

### 2.2 Nejat Kinetics Expansions

Kinetics is a portion of physics that is concerned with forces and momentum. In the Nejat Kinetics expansions, the Kinetics of spacecraft, applied by solar radiation and gravity force, are the main concern. By means of the purposed Nejat Kinetics Expansions (developed and discovered by Cyrus Nejat).

$$\begin{matrix}{}_{}^{o}{\vec{Γ}}{}_{Net - Solar}^{} = {}_{}^{1}{\vec{Γ}}{}_{1}^{} + {\sum }_{K = 2}^{a} ( {[ Setareh ]}_{K}^{T} ( {}_{}^{K}{\vec{Γ}}{}_{K}^{} ) ) & ( 2.4 ) \\ {}_{}^{o}{\vec{ϖ}}{}_{Net - Gravity}^{} = {}_{}^{1}{\vec{ϖ}}{}_{1}^{} + {\sum }_{K = 2}^{a} ( {[ Narsis ]}_{K}^{T} ( {}_{}^{K}{\vec{ϖ}}{}_{K}^{} ) ) & ( 2.5 ) \\ {}_{}^{o}{Net - SG}{}_{}^{} = {}_{}^{o}{\vec{ϖ}}{}_{Net - Gravity}^{} + {}_{}^{o}{\vec{Γ}}{}_{Net - Solar}^{} & ( 2.6 ) \\ {[ Setareh ]}_{{K}_{3 D} } = [ \begin{matrix}cos ( {\sum }_{m = 2}^{K} {β}_{m} ) & sin ( {\sum }_{m = 2}^{K} {β}_{m} ) & 0 \\ - sin ( {\sum }_{m = 2}^{K} {β}_{m} ) & cos ( {\sum }_{m = 2}^{K} {β}_{m} ) & 0 \\ 0 & 0 & 1\end{matrix} ] & ( 2.7 ) \\ {[ Narsis ]}_{{K}_{3 D} } = [ \begin{matrix}cos ( {\sum }_{m = 2}^{K} {θ}_{m} ) & sin ( {\sum }_{m = 2}^{K} {θ}_{m} ) & 0 \\ - sin ( {\sum }_{m = 2}^{K} {θ}_{m} ) & cos ( {\sum }_{m = 2}^{K} {θ}_{m} ) & 0 \\ 0 & 0 & 1\end{matrix} ] & ( 2.8 )\end{matrix}$$

where °\vec{Γ}_{Net-Solar} and ° \overline{\vec{ω}}_{Net-Gravity} are the solar and gravity forces respectively.

### 2.3 Simplified CN (Cyrus Nejat) Equations of Motion

The formulation can be more simplified by considering the attitude of the sail craft in the equations of motion. By means of the purposed Simplified CN (Cyrus Nejat) Equations of Motion.

$$\begin{matrix}\ddot{β} = ∓ \frac{2 Θ A sin ( α ) cos ( γ )}{Mr} - \frac{2 \dot{r} \dot{β}}{r} & ( 2.9 ) \\ \ddot{r} = r {\dot{β}}^{2} - \frac{μ}{{r}^{2}} ∓ \frac{2 Θ A sin ( α ) sin ( γ )}{M} & ( 2.10 ) \\ \ddot{z} = f ( t , z , \dot{z} , M ) & ( 2.11 )\end{matrix}$$

The sign of forces relates directly to the direction of the light. There are four cases can be defined.

$$\begin{matrix}1 st Approach γ = 0 from CASE I \text{:} & \\ {Γ}_{j} = 2 Θ A sin ( α ) & ( 2.12 ) \\ \ddot{β} = \frac{{Γ}_{j}}{Mr} - \frac{2 \dot{r} \dot{β}}{r} & ( 2.13 ) \\ \ddot{r} = r {\dot{β}}^{2} - \frac{μ}{{r}^{2}} & ( 2.14 ) \\ 2 nd Approach γ = β from CASE I \text{:} & \\ {Γ}_{u} = 2 Θ A sin ( α ) & ( 2.15 ) \\ \ddot{β} = \frac{{Γ}_{u} cos ( β )}{Mr} - \frac{2 \dot{r} \dot{β}}{r} & ( 2.16 ) \\ \ddot{r} = r {\dot{β}}^{2} - \frac{μ}{{r}^{2}} + \frac{{Γ}_{u} sin ( β )}{M} & ( 2.17 )\end{matrix}$$

Case I is for positive signs. The equations in the first approach are the Hamilton Equations. To remove the complexity of the Moon's shadow, it can simply transfer in a tube, as it was solved in this study.

### CHAPTER 3

### Special Spacecraft Rout in Space, Three Dimensional Orbit

By adding the Newton equation of motion in z direction with the Simplified CN (Cyrus Nejat) Equations of Motion, the following formulation is obtained;

$$\begin{matrix}\ddot{β} = ∓ \frac{2 Θ A sin ( α ) cos ( γ )}{Mr} - \frac{2 \dot{r} \dot{β}}{r} & ( 3.1 ) \\ \ddot{r} = r {\dot{β}}^{2} - \frac{μ}{{r}^{2}} ∓ \frac{2 Θ A sin ( α ) sin ( γ )}{M} & ( 3.2 ) \\ z = \frac{1}{2 M} ( {Γ}_{z} {t}^{2} ) & ( 3.3 )\end{matrix}$$

By solving the above formulation, and performing more simplifications the following results will be obtain. Since the pattern of the spacecraft is design not to in plane and it is based on mathematics, the author pursue for the patent. In the figures the θ is the same as β.

### CHAPTER 4

### Examples

### 4.1 Example 1

It this example, the Nejat Kinematics Expansions is being evaluated. In this example, the author investigated the movement of center mass of a space station located at GEO. From Nejat Kinematics Expansions, the following equations can be defined with “a” is equal to one.

°\vec{N}=r₁\hat{P}₁ (4.1)

°\dot{\vec{N}}=[\dot{r}₁\hat{P}₁+r₁(\dot{β}₁)\hat{Q}₁] (4.2)

°\ddot{\vec{N}}=[{\ddot{r}₁−r₁(\dot{β}₁)²}\hat{P}₁+{r₁(\ddot{β}₁)+2\dot{r}₁(\dot{β}₁)}\hat{Q}₁] (4.3)

### 4.2 Example 2

It this example, the Nejat Kinematics Expansions is being evaluated. In this example, the author investigated the movements of several parts of space station also by consideration of center mass of the space station located at GEO. From Nejat Kinematics Expansions, the following equations can be defined with “a” is equal to three.

$$\begin{matrix}{ }^{o} \vec{N} = {r}_{1} {\hat{P}}_{1} + {r}_{2} {\hat{P}}_{2} + {r}_{3} {\hat{P}}_{3} & ( 4.4 ) \\ {}^{o} \vec{\dot{N}} = [ \begin{matrix}{\dot{r}}_{1} {\hat{P}}_{1} + {r}_{1} ( {\dot{β}}_{1} ) {\hat{Q}}_{1} + {\dot{r}}_{2} {\hat{P}}_{2} + \\ {r}_{2} ( {\dot{β}}_{2} + {\dot{β}}_{1} ) {\hat{Q}}_{2} + {\dot{r}}_{3} {\hat{P}}_{3} + {r}_{3} ( {\dot{β}}_{3} + {\dot{β}}_{2} + {\dot{β}}_{1} ) {\hat{Q}}_{3}\end{matrix} ] & ( 4.5 ) \\ {}^{o} \vec{\ddot{N}} = {\sum }_{K = 1}^{3} [ {\begin{matrix}\{ {\ddot{r}}_{K} - {{r}_{K} ( {\sum }_{m = 1}^{K} {\dot{β}}_{m} )}^{2} \} {\hat{P}}_{K} + \\ \{ {r}_{K} ( {\sum }_{m = 1}^{K} {\ddot{β}}_{m} ) + 2 {\dot{r}}_{K} ( {\sum }_{m = 1}^{K} {\dot{β}}_{m} ) \} {\hat{Q}}_{K}\end{matrix}}_{K} ] & ( 4.6 )\end{matrix}$$

### 4.3 Example 3

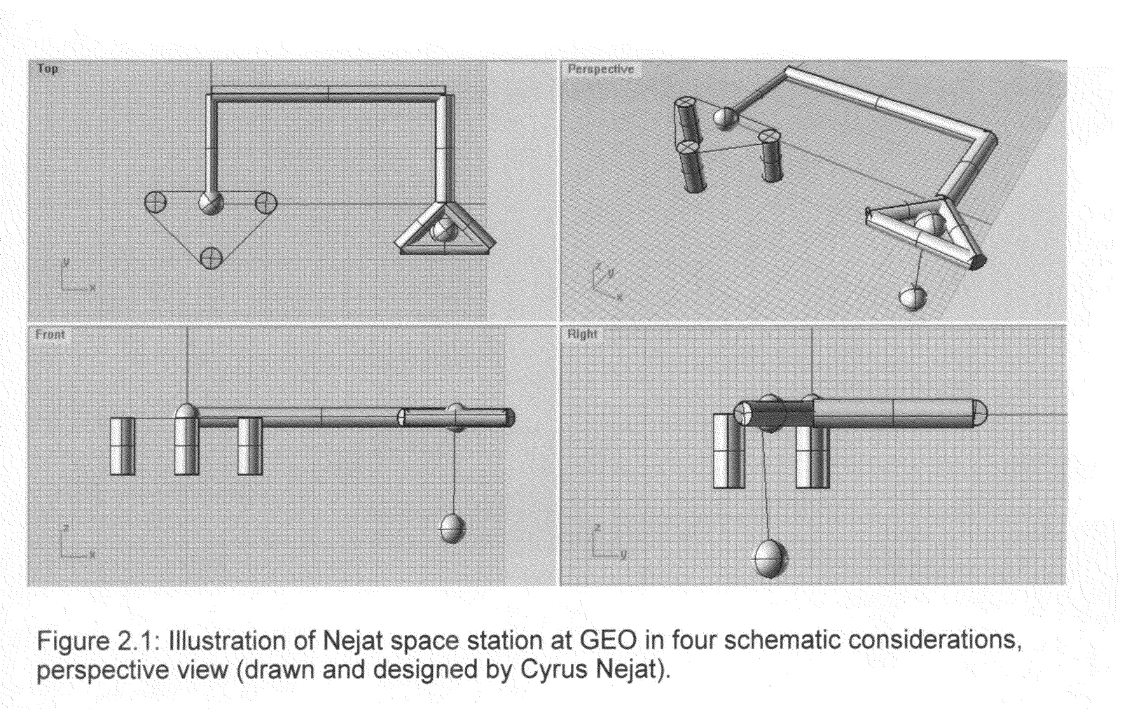

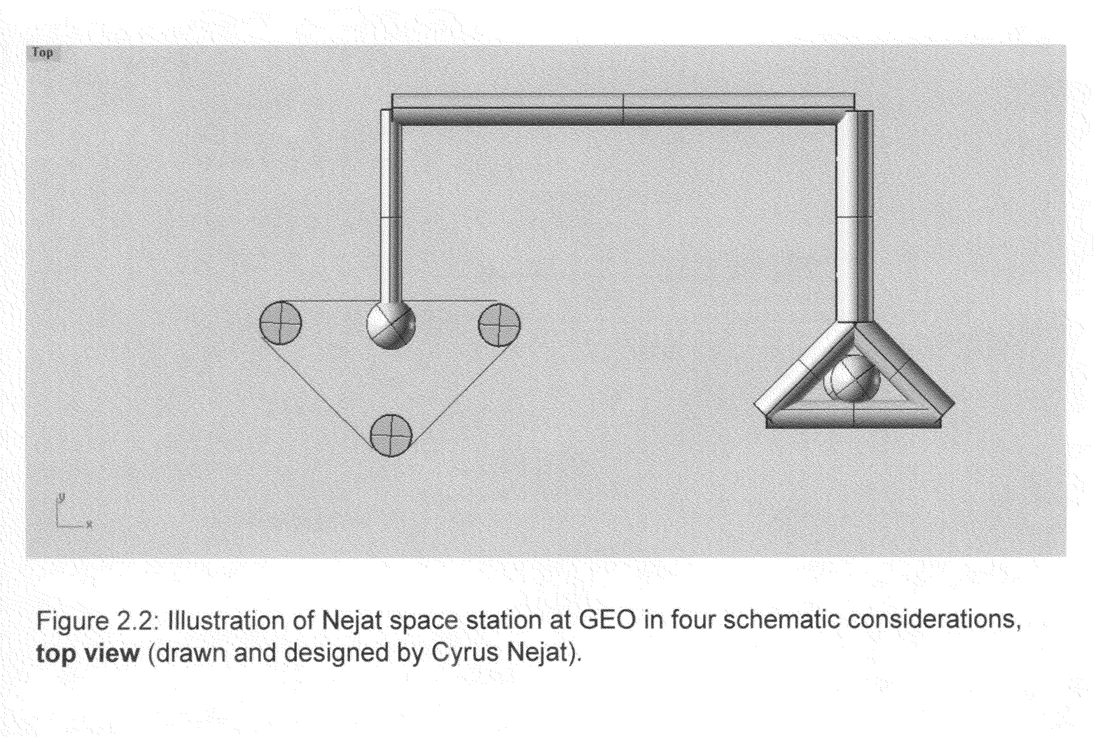

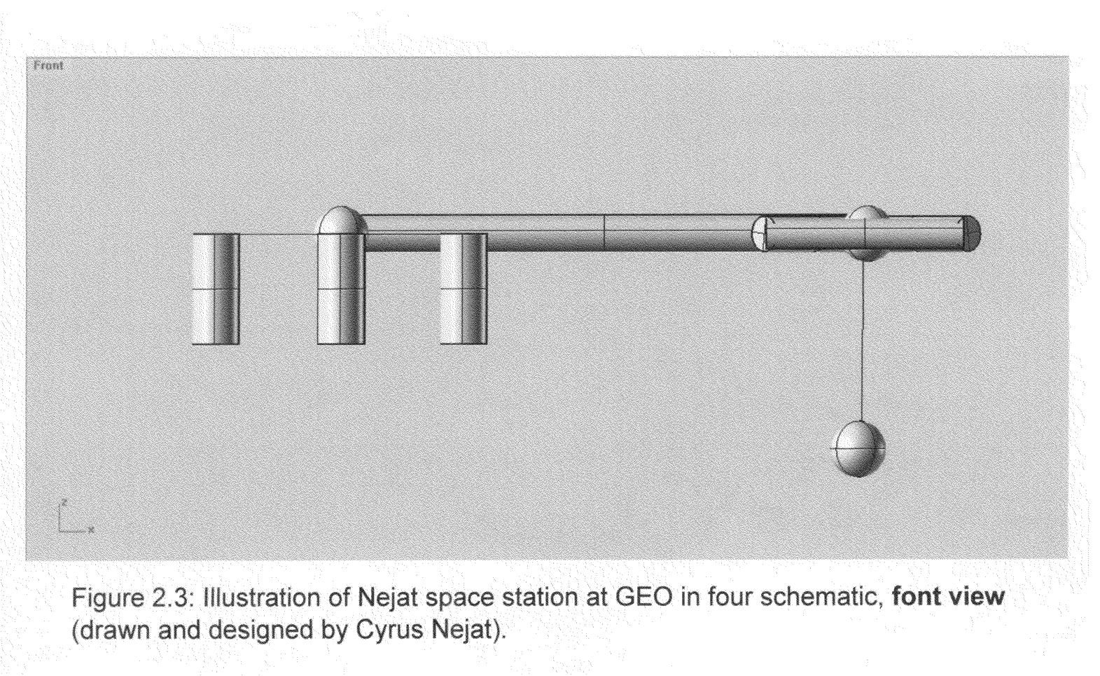

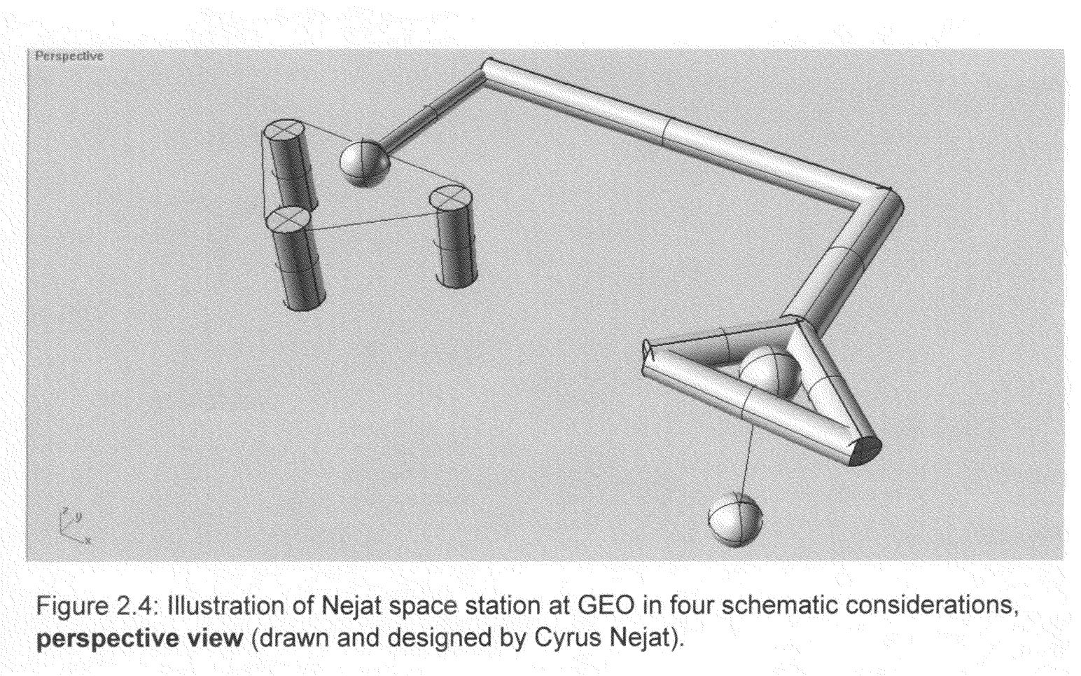

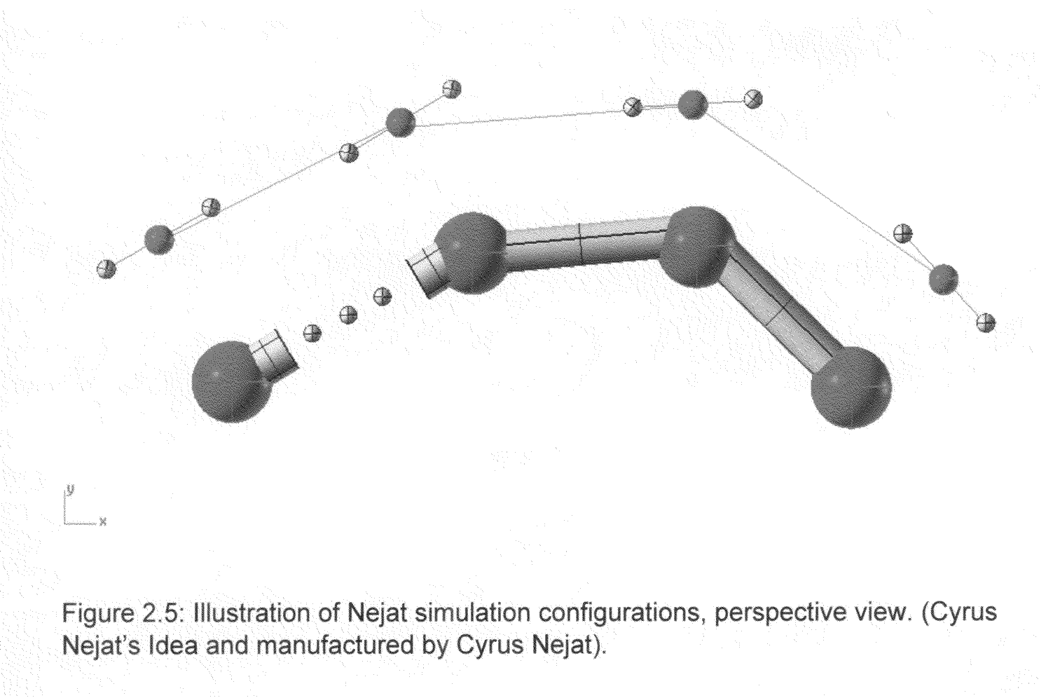

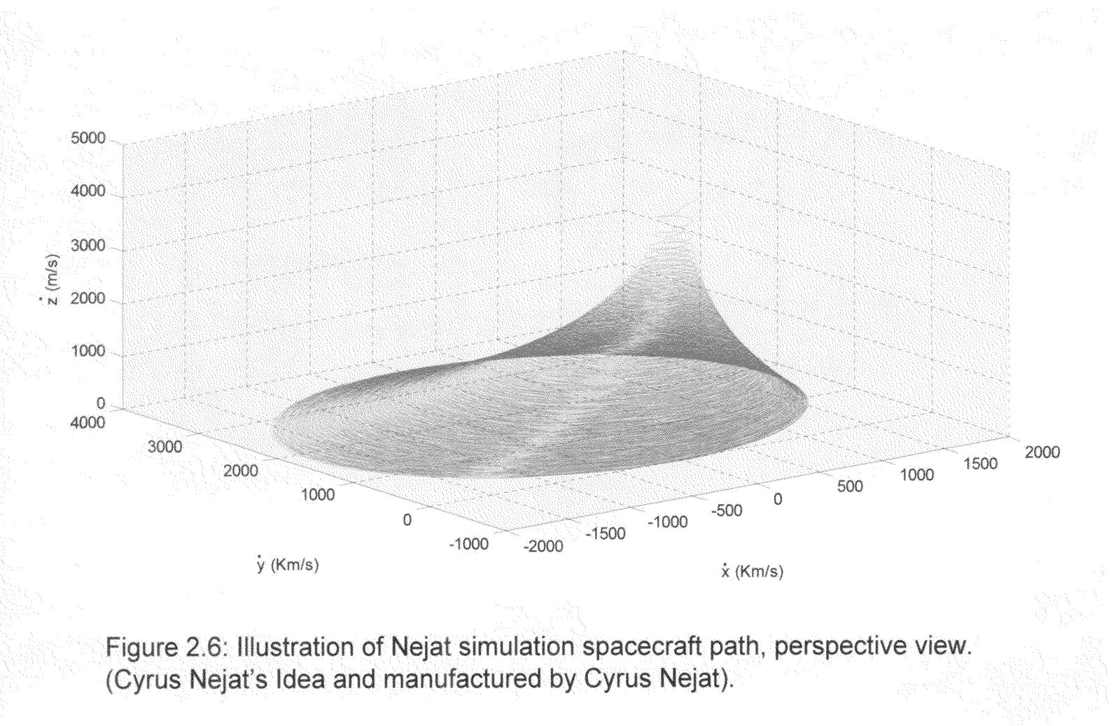

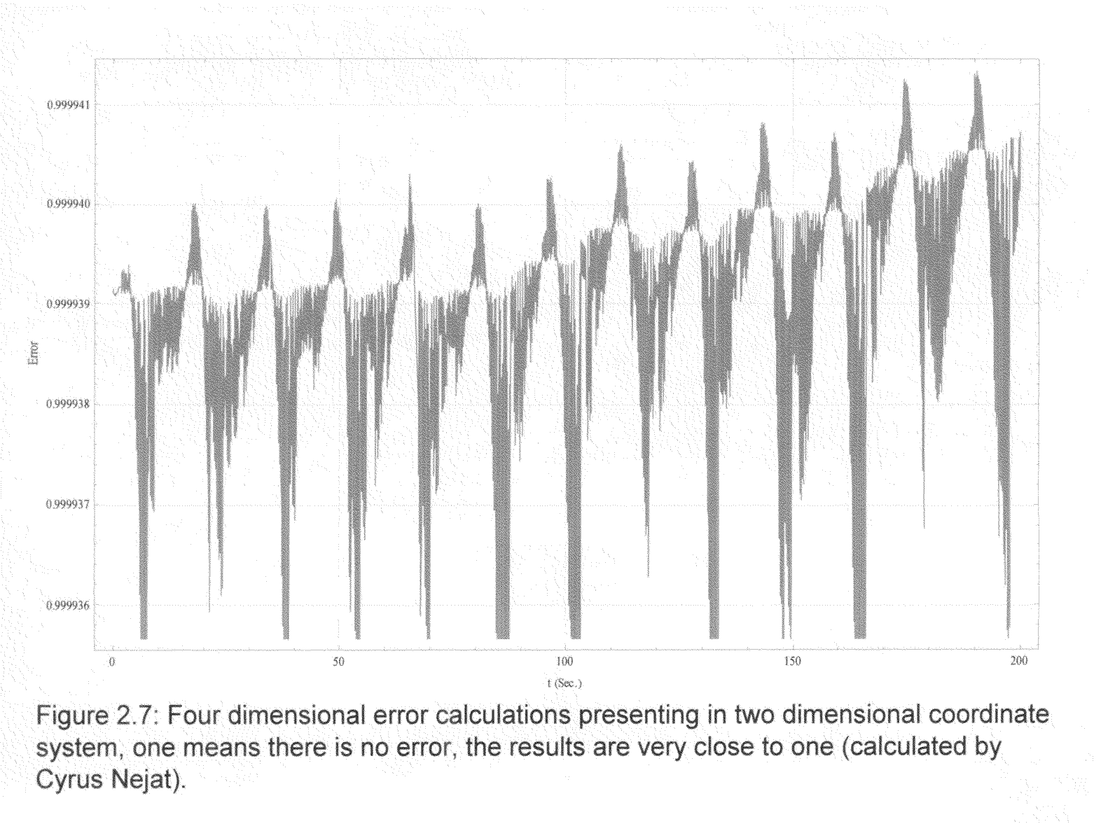

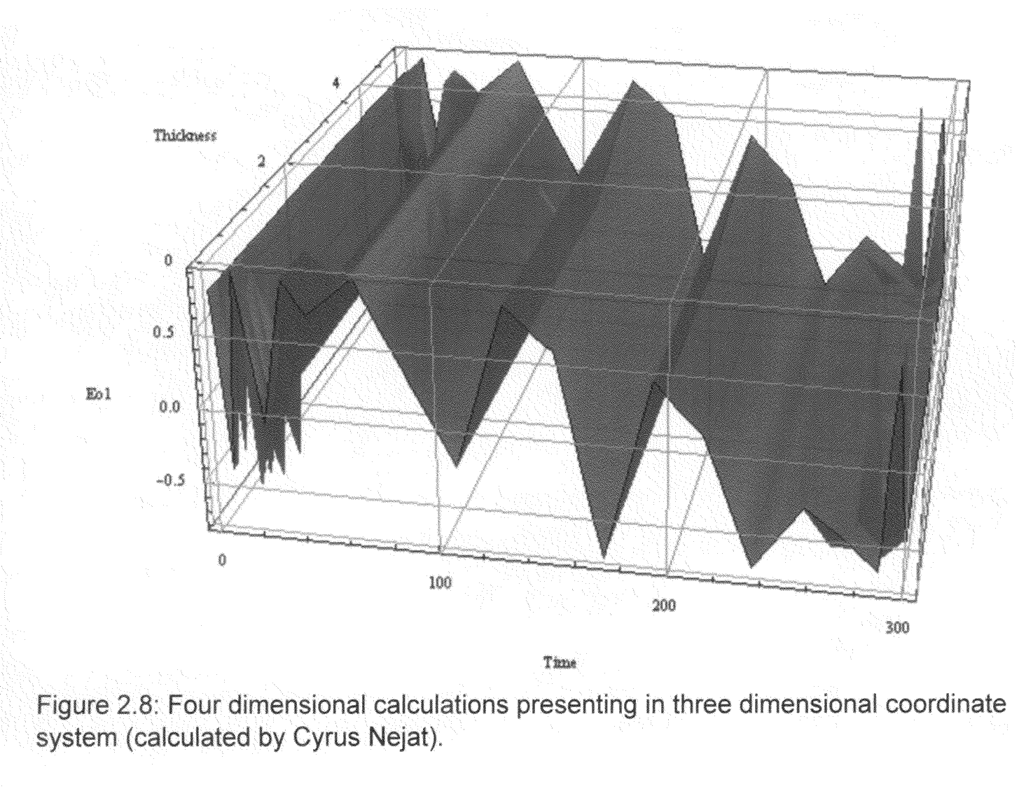

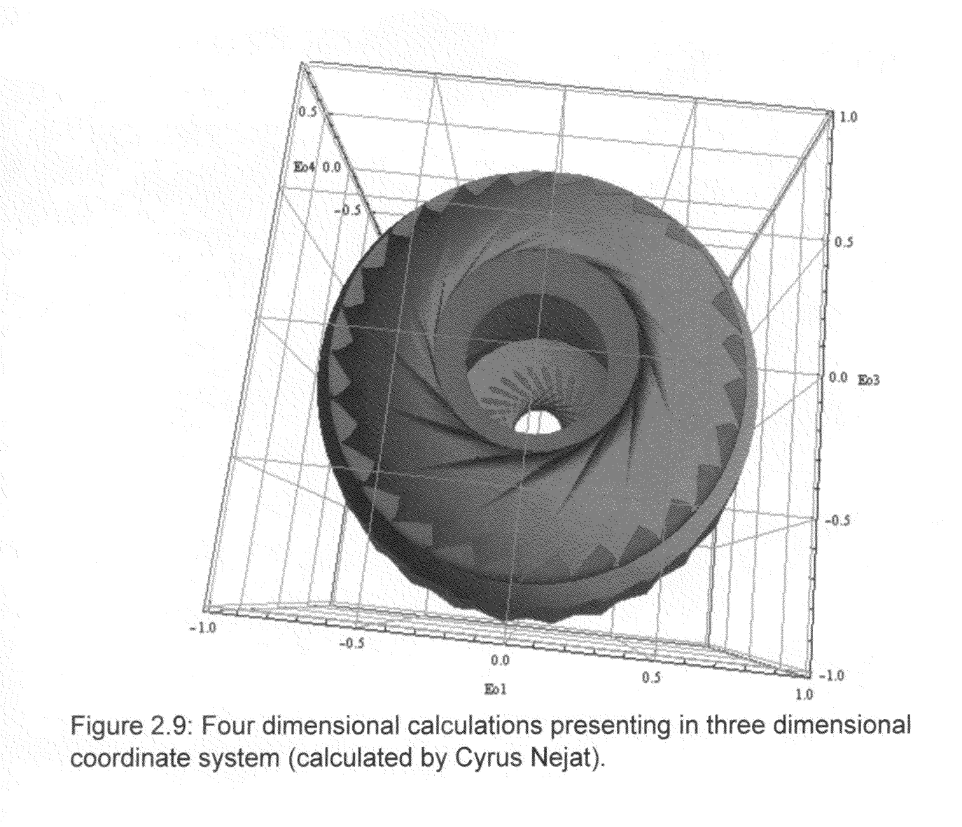

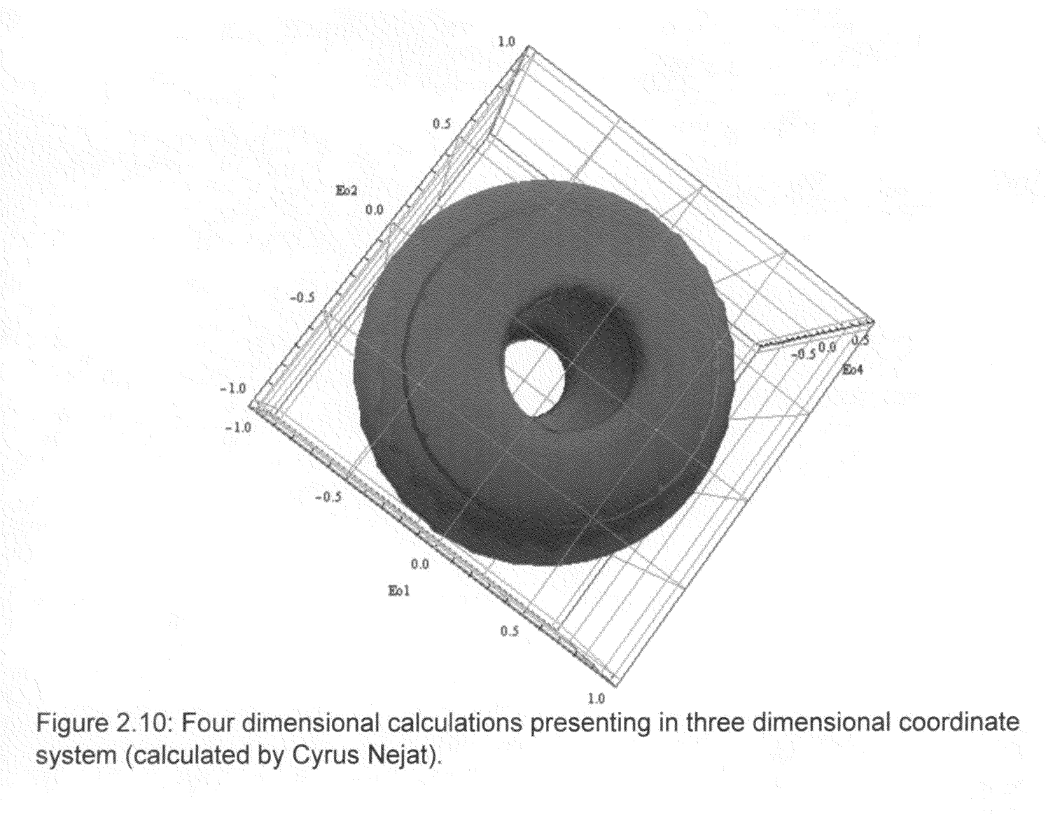

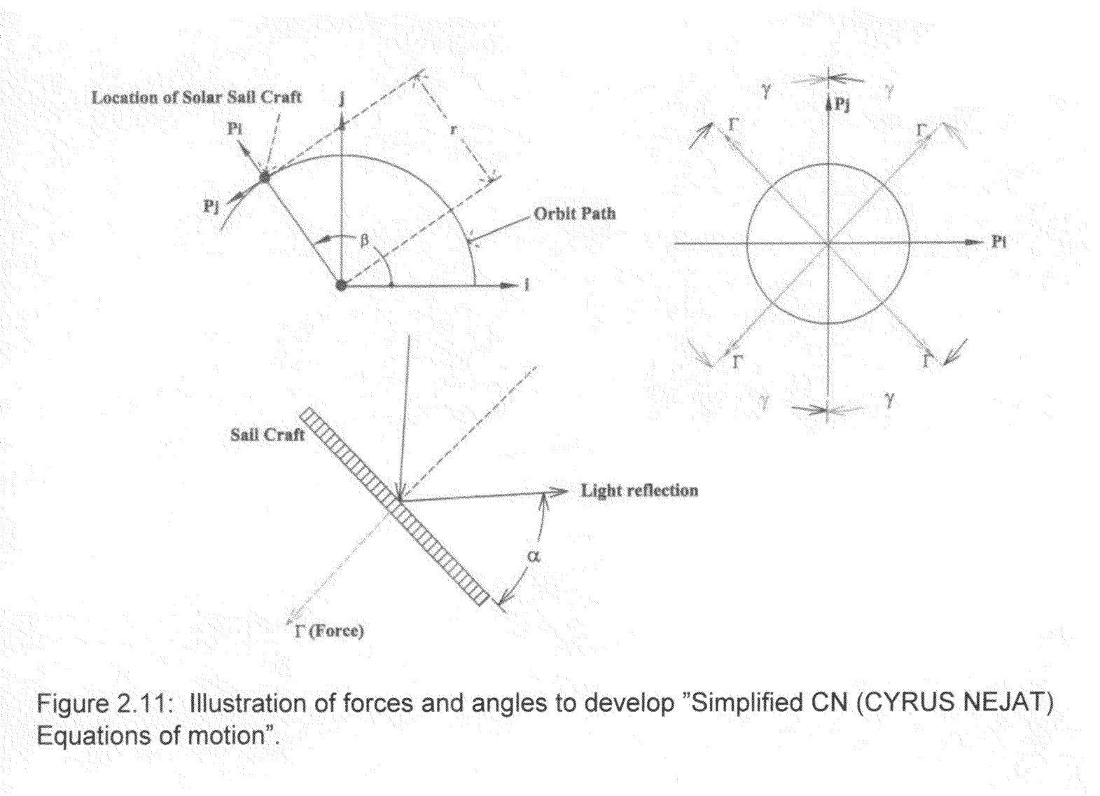

It this example, the Nejat Kinetics Expansions is being evaluated on Electromagnetic Solar Sail Spacecraft. The formulations depend on how the problem statements can be developed. For this example, if the panel is divided in b columns and a−1 rows then the Nejat Kinetics Expansions can be more expanded and be written as (derived by Cyrus Nejat):

$${( {}_{}^{o}{Net - SG}{}_{}^{} )}_{total} = {\sum }_{j = 1}^{b} {( {}_{}^{o}{\vec{ϖ}}{}_{Net - Gravity}^{} + {}_{}^{o}{\vec{Γ}}{}_{Net - Solar}^{} )}_{j} \qquad ( 4.7 )$$

where b indicates the numbers of elements in each column. In FIG. 2.10, the Electromagnetic Solar Sail Spacecraft configurations are shown. The details of Electromagnetic Solar Sail Spacecraft, by applications of gravity gradient stabilization of orbiting instruments, are also shown in FIG. 1.1 in chapter one. By combination of Nejat Kinematics Expansions and Nejat Kinetics Expansions with Lorentz equations (new notations) for orbiting equipments, the following equations can be developed (developed by Cyrus Nejat):

$$\begin{matrix}↑ \ddot{N} = \frac{1}{M} ( ↑ {( {}_{}^{o}{Net - SG}{}_{}^{} )}_{total} + {n}_{c} {q}_{c} ↑ {Ψ}_{2}^{S} + {n}_{c} {q}_{c} ↑ {Ψ}_{3}^{S} ) & ( 4.8 ) \\ ↑ {Ψ}_{2}^{S} = [ \begin{matrix}{E}_{xx} & {E}_{xy} & {E}_{xz} \\ {E}_{yx} & {E}_{yy} & {E}_{yz} \\ {E}_{zx} & {E}_{zy} & {E}_{zz}\end{matrix} ] [ \begin{matrix}{\hat{P}}_{k} \\ {\hat{Q}}_{k} \\ \hat{Z}\end{matrix} ] & ( 4.9 ) \\ ↑ {Ψ}_{3}^{S} = [ \begin{matrix}{\hat{P}}_{k} & {\hat{Q}}_{k} & \hat{Z} \\ {\dot{N}}_{1} & {\dot{N}}_{2} & \dot{δ} \\ {B}_{x} & {B}_{y} & {B}_{z}\end{matrix} ] & ( 4.10 )\end{matrix}$$

where \ddot{N}_{z} is zero for plane maneuvering; in case of oscillation, \ddot{δ} will be applied.

1. Nejat Space Station (FIG. 2.1, FIG. 2.2, FIG. 2.3)

2. Nejat Kinematics Expansions (equations 2.1, 2.2, 2.3)

3. Nejat Kinetics Expansions (equations 2.4, 2.5, 2.6, 2.7, 2.8)

4. Nejat Simulation Configuration (FIG. 2.5)

5. Simplified CN (Cyrus Nejat) Equations of Motion

6. Special Spacecraft Rout in Space (FIGS. 3.1, 3.2, 3.3, 3.4)
